(19) United States
(12) Patent Application Publication
(10) Pub. No.: US 2011/0246187 A1
(43) Pub. Date: Oct. 6, 2011

(54) SPEECH SIGNAL PROCESSING

(75) Inventors: Sriram Srinivasan, Eindhoven (NL); Ashish Vijay Pandharipande, Eindhoven (NL)

(73) Assignee: KONINKLIJKE PHILIPS ELECTRONICS N.V., EINDHOVEN (NL)

(21) Appl. No.: 13/133,797

(22) PCT Filed: Dec. 10, 2009
(86) PCT No.: PCT/IB2009/055658

§ 371 Date: Jun. 9, 2011

(30) Foreign Application Priority Data
Dec. 16, 2008 (EP) 08171842.1

(51) Int. Cl. G10L 19/00

(52) U.S. Cl. 704/201; 704/E19.001

(57) ABSTRACT

A speech signal processing system comprises an audio processor (103) for providing a first signal representing an acoustic speech signal of a speaker. An EMG processor (109) provides a second signal which represents an electromyographic signal for the speaker captured simultaneously with the acoustic speech signal. A speech processor (105) is arranged to process the first signal in response to the second signal to generate a modified speech signal. The processing may for example be a beam forming, noise compensation, or speech encoding. Improved speech processing may be achieved in particular in an acoustically noisy environment.

### FIELD OF THE INVENTION

The invention relates to speech signal processing, such as e.g. speech encoding or speech enhancement.

### BACKGROUND OF THE INVENTION

Processing of speech has become of increasing importance and for example advanced encoding and enhancement of speech signals has become widespread.

Typically, the acoustic speech signal from a speaker is captured and converted to the digital domain wherein advanced algorithms may be applied to process the signal. For example, advanced speech encoding or speech intelligibility enhancement techniques may be applied to the captured signal.

However, a problem of many such conventional processing algorithms is that they tend not to be optimal in all scenarios. For example, in many scenarios the captured microphone signal may be a suboptimal representation of the actual speech produced by the speaker. This may for example occur due to distortions in the acoustic path or in the capturing by the microphone. Such distortions may potentially reduce the fidelity of the captured speech signal. As a specific example, the frequency response of the speech signal may be modified. As another example, the acoustic environment may include substantial noise or interference resulting in the captured signal not just representing the speech signal but rather being a combined speech and noise/interference signal. Such noise may substantially affect the processing of the resulting speech signal and may substantially reduce the quality and intelligibility of the generated speech signal.

For example, traditional methods of speech enhancement have largely been based on applying acoustic signal processing techniques to the input speech signals so as to improve the desired Signal-to Noise Ratio (SNR). However, such methods are fundamentally limited by the SNR and the operating environment conditions, and therefore cannot always provide good performance.

In other areas it has been proposed to measure signals representing movement of the speaker's vocal system in areas close to the larynx and sublingual areas below the jaw. It has been proposed that such measurements of elements of the speaker's vocal system can be converted into speech and therefore can be used to generate speech signals for the speech-impaired thereby allowing them to communicate using speech. These approaches are based on the rationale that such signals are produced in subsystems of the human speech system before the final conversion to acoustic signals in a final subsystem that includes the mouth, lips, tongue and nasal cavity. However this method is limited in its efficacy and cannot by itself reproduce speech perfectly.

In U.S. Pat. No. 5,729,694 it has been proposed to direct an electromagnetic wave towards speech organs, such as the larynx, of a speaker. A sensor then detects the electromagnetic radiation scattered by the speech organs and this signal is in conjunction with simultaneously recorded acoustic speech information used to perform a complete mathematical coding of the acoustic speech. However, the described approach tends to be complex and cumbersome to implement and requires impractical and typically expensive equipment to measure electromagnetic signals. Furthermore, measurements of electromagnetic signals tend to be relatively inaccurate and accordingly the resulting speech encoding tends to be suboptimal and in particular the resulting encoded speech quality tends to be suboptimal.

Hence, an improved speech signal processing would be advantageous and in particular a system allowing increased flexibility, reduced complexity, increased user convenience, improved quality, reduced cost and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a speech signal processing system comprising: first means for providing a first signal representing an acoustic speech signal for a speaker; second means for providing a second signal representing an electromyographic signal for the speaker captured simultaneously with the acoustic speech signal, and processing means for processing the first signal in response to the second signal to generate a modified speech signal.

The invention may provide an improved speech processing system. In particular, a sub vocal signal may be used to enhance speech processing while maintaining a low complexity and/or cost. Furthermore, the inconvenience to the user may be reduced in many embodiments. The use of an electromyographic signal may provide information that is not conveniently available for other types of sub vocal signals. For example, an electromyographic signal may allow speech related data to be detected prior to the speaking actually commencing.

The invention may in many scenarios provide improved speech quality and may additionally or alternatively reduce cost and/or complexity and/or resource requirements.

The first and second signals may or may not be synchronized (e.g. one may be delayed relatively to the other) but may represent a simultaneous acoustic speech signal and electromyographic signal. Specifically, the first signal may represent the acoustic speech signal in a first time interval and the second signal may represent the electromyographic signal in a second time interval where the first time interval and the second time interval are overlapping time intervals. The first signal and the second signal may specifically provide information of the same speech from the speaker in at least a time interval.

In accordance with an optional feature of the invention, the speech signal processing system further comprises an electromyographic sensor arranged to generate the electromyographic signal in response to a measurement of skin surface conductivity of the speaker.

This may provide a determination of the electromyographic signal which provides a high quality second signal while providing for a user friendly and less intrusive sensor operation.

In accordance with an optional feature of the invention, the processing means is arranged to perform a speech activity detection in response to the second signal and the processing means is arranged to modify a processing of the first signal in response to the speech activity detection.

This may provide improved and/or facilitated speech operation in many embodiments. In particular, it may allow improved detection and speech activity dependent processing in many scenarios, such as for example in noisy environments. As another example, it may allow speech detection to be targeted to a single speaker in an environment where a plurality of speakers are speaking simultaneously.

The speech activity detection may for example be a simple binary detection of whether speech is present or not.

In accordance with an optional feature of the invention, the speech activity detection is a pre-speech activity detection.

This may provide improved and/or facilitated speech operation in many embodiments. Indeed, the approach may allow speech activity to be detected prior to the speaking actually starting thereby allowing pre-initialization and faster convergence of adaptive operations.

In accordance with an optional feature of the invention, the processing comprises an adaptive processing of the first signal, and the processing means is arranged to adapt the adaptive processing only when the speech activity detection meets a criterion.

The invention may allow improved adaptation of adaptive speech processing and may in particular allow an improved adaptation based on an improved detection of when the adaptation should be performed. Specifically, some adaptive processing is advantageously adapted only in the presence of speech and other adaptive processing is advantageously adapted only in the absence of speech. Thus, an improved adaptation and thus resulting speech processing and quality may in many situations be achieved by selecting when to adapt the adaptive processing based on an electromyographic signal.

The criterion may for example for some applications require that speech activity is detected and for other applications may require that speech activity is not detected.

In accordance with an optional feature of the invention, the adaptive processing comprises an adaptive audio beam forming processing.

The invention may in some embodiments provide improved audio beam forming. Specifically, a more accurate adaptation and beamforming tracking may be achieved. For example, the adaptation may be more focused on time intervals in which the user is speaking.

In accordance with an optional feature of the invention, the adaptive processing comprises an adaptive noise compensation processing.

The invention may in some embodiments provide improved noise compensation processing. Specifically, a more accurate adaptation of the noise compensation may be achieved e.g. by an improved focus of the noise compensation adaptation on time intervals in which the user is not speaking.

The noise compensation processing may for example be a noise suppression processing or an interference canceling/reduction processing.

In accordance with an optional feature of the invention, the processing means is arranged to determine a speech characteristic in response to the second signal, and to modify a processing of the first signal in response to the speech characteristic.

This may in many embodiments provide improved speech processing. In many embodiments it may provide an improved adaptation of the speech processing to the specific properties of the speech. Furthermore, in many scenarios the electromyographic signal may allow the speech processing to be adapted prior to the speech signal being received.

In accordance with an optional feature of the invention, the speech characteristic is a voicing characteristic and the processing of the first signal is varied dependent on a current degree of voicing indicated by the voicing characteristic.

This may allow a particularly advantageous adaptation of the speech processing. In particular, the characteristics associated with different phonemes may vary substantially (e.g. voiced and unvoiced signals) and accordingly an improved detection of the voicing characteristic based on an electromyographic signal may result in a substantially improved speech processing and resulting speech quality.

In accordance with an optional feature of the invention, the modified speech signal is an encoded speech signal and the processing means is arranged to select a set of encoding parameters for encoding the first signal in response to the speech characteristic.

This may allow an improved encoding of a speech signal. For example, the encoding may be adapted to reflect whether the speech signal is predominantly a sinusoidal signal or a noise-like signal thereby allowing the encoding to be adapted to reflect this characteristic.

In accordance with an optional feature of the invention, the modified speech signal is an encoded speech signal, and the processing of the first signal comprises a speech encoding of the first signal.

The invention may in some embodiments provide improved speech encoding.

In accordance with an optional feature of the invention, the system comprises a first device comprising the first and second means and a second device remote from the first device and comprising the processing device, and the first device further comprise means for communicating the first signal and the second signal to the second device.

This may provide an improved speech signal distribution and processing in many embodiments. In particular, it may allow the advantages of the electromyographic signal for individual speakers to be utilized while allowing a distributed and/or centralized processing of the required functionality.

In accordance with an optional feature of the invention, the second device further comprises means for transmitting the speech signal to a third device over a speech only communication connection.

This may provide an improved speech signal distribution and processing in many embodiments. In particular, it may allow the advantages of the electromyographic signal for individual speakers to be utilized while allowing a distributed and/or centralized processing of the required functionality. Furthermore, it may allow the advantages to be provided without requiring end-to-end data communication. The feature may in particular provide improved backwards compatibility for many existing communication systems including for example mobile or fixed network telephone systems.

According to an aspect of the invention there is provided a method of operation for a speech signal processing system, the method comprising: providing a first signal representing an acoustic speech signal of a speaker; providing a second signal representing an electromyographic signal for the speaker captured simultaneously with the acoustic speech signal, and processing the first signal in response to the second signal to generate a modified speech signal.

According to an aspect of the invention there is provided a computer program product enabling the carrying out of the above method

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a speech signal processing system in accordance with some embodiments of the invention;

FIG. 2 illustrates an example of a speech signal processing system in accordance with some embodiments of the invention;

FIG. 3 illustrates an example of a speech signal processing system in accordance with some embodiments of the invention; and

FIG. 4 illustrates an example of a communication system comprising a speech signal processing system in accordance with some embodiments of the invention.

### DETAILED DESCRIPTION OF SOME EMBODIMENTS OF THE INVENTION

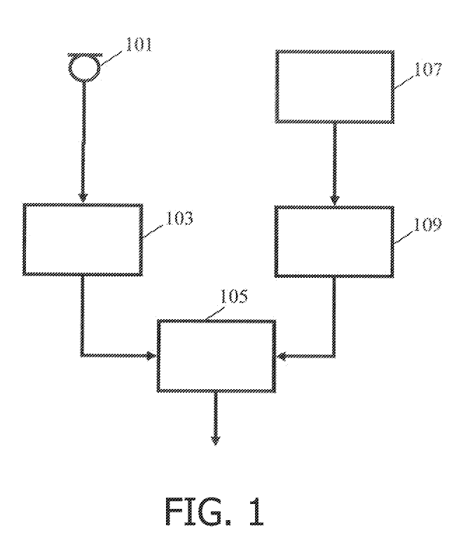

FIG. 1 illustrates an example of a speech signal processing system in accordance with some embodiments of the invention.

The speech signal processing system comprises a recording element which specifically is a microphone 101. The microphone 101 is located close to a speaker's mouth and captures the acoustic speech signal of the speaker. The microphone 101 is coupled to an audio processor 103 which may process the audio signal. For example, the audio processor 103 may comprise functionality for e.g. filtering, amplifying and converting the signal from the analog to the digital domain.

The audio processor 103 is coupled to a speech processor 105 which is arranged to perform speech processing. Thus, the audio processor 103 provides a signal representing the captured acoustic speech signal to the speech processor 105 which then proceeds to process the signal to generate a modified speech signal. The modified speech signal may for example be a noise compensated, beamformed, speech enhanced and/or encoded speech signal.

The system furthermore comprises an electromyographic (EMG) sensor 107 which is capable of capturing a electromyographic signal for the speaker. An electromyographic signal is captured which represents the electrical activity of one or more muscles of the speaker.

Specifically, the EMG sensor 107 may measure a signal reflecting the electrical potential generated by muscle cells when these cells contract, and also when the cells are at rest. The electrical source is typically a muscle membrane potential of about 70 mV. Measured EMG potentials typically range between less than 50 μV and up to 20 to 30 mV, depending on the muscle under observation.

Muscle tissue at rest is normally electrically inactive. However, when the muscle is voluntarily contracted, action potentials begin to appear. As the strength of the muscle contraction is increased, more and more muscle fibers produce action potentials. When the muscle is fully contracted, there should appear a disorderly group of action potentials of varying rates and amplitudes (a complete recruitment and interference pattern). In the system of FIG. 1, such variations in the electrical potential is detected by the EMG sensor 107 and fed to an EMG processor 109 which proceeds to process the received EMG signal.

The measurement of the electrical potentials is in the specific example performed by a skin surface conductivity measurement. Specifically, electrodes may be attached to the speaker in the area around the larynx and other parts instrumental in the generation of human speech. The skin conductivity detection approach may in some scenarios reduce the accuracy of the measured EMG signal but the inventors have realized that this is typically acceptable for many speech applications that only partially rely on the EMG signal (e.g. in contrast to medical applications). The use of surface measurements may reduce the inconvenience to the user and may in particular allow a user to move freely.

In other embodiments, more accurate intrusive measurements may be used to capture the EMG signal. For example, needles may be inserted into the muscle tissue and the electrical potentials may be measured.

The EMG processor 109 may specifically amplify, filter and convert the EMG signal from the analog to the digital domain.

The EMG processor 109 is further coupled to the speech processor 105 and provides this with a signal representing the captured EMG signal. In the system, the speech processor 105 is arranged to process the first signal (corresponding to the acoustic signal) dependent on the second signal provided by the EMG processor 109 and representing the measured EMG signal.

Thus, in the system the electromyographic signal and the acoustic signals are captured simultaneously, i.e. such that they at least within a time interval relate to the same speech generated by the speaker. Thus, the first and second signals reflect corresponding acoustic and electromyographic signals that relate to the same speech. Accordingly, the processing of the speech processor 105 may jointly take into account the information provided by both the first and second signals.

However, it will be appreciated that the first and second signals need not be synchronized and that for example one signal may be delayed relative to the other with reference to the speech generated by the user. Such a difference in the delay of the two paths may for example occur in the acoustic domain, the analog domain and/or the digital domain.

For brevity and conciseness, signals representing the captured audio signal may in the following be referred to as audio signals and signals representing the captured electromyographic signal may in the following be referred to as electromyographic (or EMG) signals.

Thus, in the system of FIG. 1, an acoustic signal is captured as in traditional systems using a microphone 101. Furthermore, a non-acoustic sub-vocal EMG signal is captured using a suitable sensor e.g., placed on the skin close to the larynx. The two signals are then both used to generate a speech signal. Specifically, the two signals may be combined to produce an enhanced speech signal.

For example, a human speaker in a noisy environment may try to communicate with another user who is only interested in the speech content and not in the audio environment as a whole. In such an example, the listening user may carry a personal sound device that performs speech enhancement to generate a more legible speech signal. In the example, the speaker communicates verbally (mouthed speech) and in addition wears a skin conductivity sensor capable of detecting an EMG signal that contains information of the content intended to be spoken. In the example, the detected EMG signal is communicated from the speaker to the receiver's personal sound device (e.g., using radio transmission) whereas the acoustic speech signal is captured by a microphone of the personal sound device itself. Thus, the personal sound device receives an acoustic signal corrupted by ambient noise and distorted by reverberations resulting from the acoustic channel between the speaker and the microphone etc. In addition, a sub-vocal EMG signal indicative of the speech is received. However, the EMG signal is not affected by the acoustic environment and is specifically not affected by the acoustic noise and/or acoustic transfer functions. Accordingly, a speech enhancement process may be applied to the acoustic signal with the processing being dependent on the EMG signal. For example, the processing may attempt to generate an enhanced estimate of the speech part of the acoustic signal by a combined processing of the acoustic signal and the EMG signal.

It will be appreciated that in different embodiments, different speech processing may be applied.

In some embodiments, the processing of the acoustic signal is an adaptive processing which is adapted in response to the EMG signal. Specifically, when to apply the adaptation of the adaptive processing may be based on a speech activity detection which is based on the EMG signal.

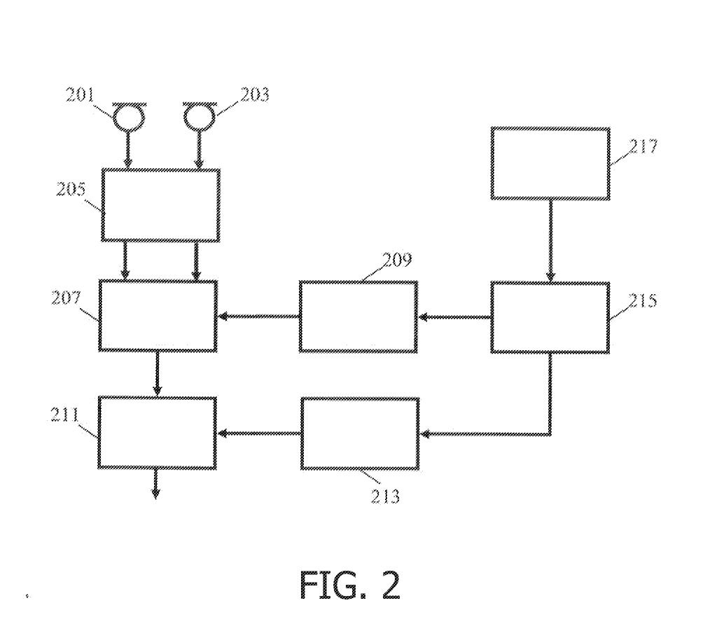

An example of such an adaptive speech signal processing system is illustrated in FIG. 2.

In the example, the adaptive speech signal processing system comprises a plurality of microphones of which two 201, 203 are illustrated. The microphones 201, 203 are coupled to an audio processor 205 which may amplify, filter and digitize the microphone signals.

The digitized acoustic signals are then fed to a beamformer 207 which is arranged to perform audio beamforming. Thus, the beamformer 207 can combine the signals from the individual microphones 201, 203 of the microphone array such that an overall audio directionality is obtained. Specifically, the beamformer 207 may seek to generate a main audio beam and direct this towards the speaker.

It will be appreciated that many different audio beamforming algorithms will be known to the skilled person and that any suitable beamforming algorithm may be used without detracting from the invention. An example of a suitable beamforming algorithm is for example disclosed in U.S. Pat. No. 6,774,934. In the example, each audio signal from a microphone is filtered (or simply weighted by a complex value) such that audio signals from the speaker to the different microphones 201, 203 add coherently. The beamformer 207 tracks the movement of the speaker relative to the microphone array 201, 203 and thus adapts the filters (weights) applied to the individual signals.

In the system, the adaptation operation of the beamformer 207 is controlled by a beamform adaptation processor 209 coupled to the beamformer 207.

The beamformer 211 provides a single output signal which corresponds to the combined signals from the different microphones 201, 203 (following the beamform filtering/weighting). Thus, the output of the beamformer 207 corresponds to that which would be received by a directional microphone and will typically provide an improved speech signal as the audio beam is directed towards the speaker.

In the example, the beamformer 207 is coupled to an interference cancellation processor 211 which is arranged to perform a noise compensation processing. Specifically, the interference cancellation processor 211 implements an adaptive interference cancellation process which seeks to detect significant interferences in the audio signal and remove these. For example, the presence of strong sinusoids not relating to the speech signal may be detected and compensated for.

It will be appreciated that many different audio noise compensation algorithms will be known to the skilled person and that any suitable algorithm may be used without detracting from the invention. An example of a suitable interference canceling algorithm is for example disclosed in U.S. Pat. No. 5,740,256.

The interference cancellation processor 211 thus adapts the processing and noise compensation to the characteristics of the current signal. The interference cancellation processor 211 is further coupled to a cancellation adaptation processor 213 which controls the adaptation of the interference cancellation processing performed by the interference cancellation processor 211.

It will be appreciated that although the system of FIG. 2 employs both beamforming and interference cancellation to improve the speech quality, each of these processes may be employed independently of the other and that a speech enhancement system may often employ only one of these.

The system of FIG. 2 further comprises an EMG processor 215 coupled to an EMG sensor 217 (which may correspond to the EMG sensor 107 of FIG. 1). The EMG processor 215 is coupled to the beamform adaptation processor 209 and the cancellation adaptation processor 213 and may specifically amplify, filter and digitize the EMG signal before feeding it to the adaptation processors 209, 213.

In the example, the beamform adaptation processor 209 performs speech activity detection on the EMG signal received from the EMG processor 215. Specifically, the beamform adaptation processor 209 may perform a binary speech activity detection indicative of whether the speaker is speaking or not. The beamformer is adapted when the desired signal is active and the interference canceller is adapted when the desired signal is not active. Such activity detection can be performed in a robust manner using the EMG signal as it only captures the desired signal and is free from acoustic disturbances.

Thus, robust activity detection can be performed using this signal. For example, the desired signal may be detected to be active if the average energy of the captured EMG signal is above a certain first threshold, and inactive if below a certain second threshold.

In the example, the beamform adaptation processor 209 simply controls the beamformer 207 such that adaptation of the beamforming filters or weights is only based on the audio signals which are received during time intervals when the speech activity detection indicates that speech is indeed generated by the speaker. However, during time intervals where the speech activity detection indicates that no speech is generated by the user, the audio signals are ignored with respect to the adaptation.

This approach may provide an improved beamforming and thus an improved quality of the speech signal at the output of the beamformer 207. The use of a speech activity detection based on the sub vocal EMG signal may provide improved adaptation as this is more likely to be focused on time intervals where the user is actually speaking. For example, conventional audio based speech detectors tend to provide inaccurate results in noisy environments as it is typically difficult to differentiate between speech and other audio sources. Furthermore, a reduced complexity processing can be achieved as simpler voice activity detection can be utilized. Furthermore, the adaptation may be more focused on the specific speaker as the speech activity detection is exclusively based on sub vocal signals derived for the specific desired speaker and is not affected or degraded by the presence of other active speakers in the acoustic environment.

It will be appreciated that in some embodiments, the speech activity detection may be based on both the EMG signal and the audio signal. For example, the EMG based speech activity algorithm may be supplemented by a conventional audio based speech detection. In such a case, the two approaches may be combined for example by requiring that both algorithms must independently indicate speech activity or e.g. by adjusting a speech activity threshold for one measure in response to the other measure.

Similarly, the cancellation adaptation processor 213 may perform a speech activity detection and control the adaptation of the processing applied to the signal by the interference cancellation processor 211.

In particular, the cancellation adaptation processor 213 may perform the same voice activity detection as the beamform adaptation processor 209 in order to generate a simple binary voice activity indication. The cancellation adaptation processor 213 may then control the adaptation of the noise compensation/interference cancellation such that this adaptation only occurs when the speech activity indication meets a given criterion. Specifically, the adaptation may be limited to the situation when no speech activity is detected. Thus, whereas the beam forming is adapted to the speech signal, the interference cancellation is adapted to the characteristics measured when no speech is generated by the user and thus to the scenario where the captured acoustic signals are dominated by the noise in the audio environment.

This approach may provide improved noise compensation/interference cancellation as it may allow an improved determination of the characteristics of the noise and interference thereby allowing a more efficient compensation/cancellation. The use of a speech activity detection based on the sub vocal EMG signal may provide improved adaptation as this is more likely to be focused on time intervals where the user is not speaking thereby reducing the risk that elements of the speech signal may be considered as noise/interference. In particular, a more accurate adaptation in noisy environments and/or targeted to a specific speaker out of a plurality of speakers in the audio environment can be achieved.

It will be appreciated that in a combined system such as that of FIG. 2, the same speech activity detection can be used for both the beamformer 207 and the interference cancellation processor 211.

The speech activity detection may specifically be a pre-speech activity detection. Indeed, a substantial advantage of the EMG based speech activity detection is that it may not only allow improved and speaker targeted speech activity detection but that it may additionally allow pre-speech speech activity detection.

Indeed, the inventors have realized that improved performance can be achieved by adapting speech processing based on using an EMG signal to detect that speech is about to start. Specifically, the speech activity detection may be based on measuring the EMG signals generated by the brain just prior to speech production. These signals are responsible for stimulating the speech organs to actually produce the audible speech signal and can be detected and measured even when there is just an intention to speak, but with only slight or even no audible sound being made, e.g., when a person reads to himself.

Thus, the use of EMG signals for voice activity detection provides substantial advantages. For example, it may reduce the delays in adapting to the speech signal or may e.g. allow speech processing to be pre-initialized for the speech.

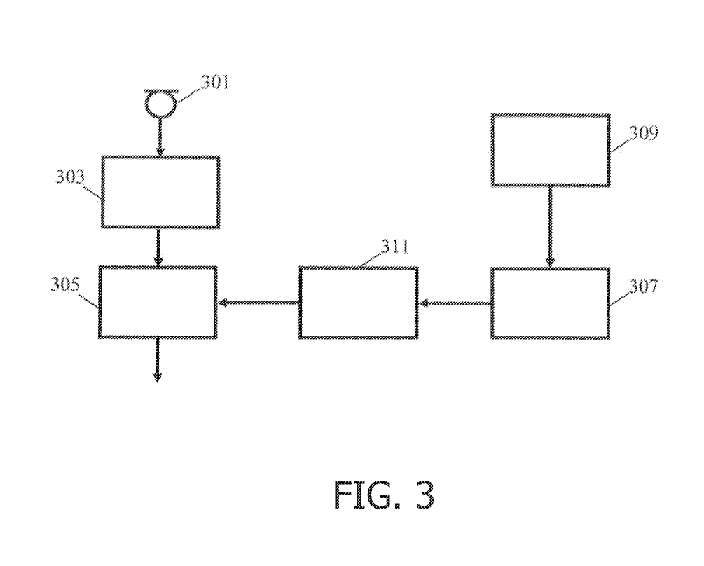

In some embodiments, the speech processing may be an encoding of the speech signal. FIG. 3 illustrates an example of a speech signal processing system for encoding a speech signal.

The system comprises a microphone 301 which captures an audio signal comprising the speech to be encoded. The microphone 301 is coupled to an audio processor 303 which for example may comprise functionality for amplifying, filtering, and digitizing the captured audio signal. The audio processor 303 is coupled to a speech encoder 305 which is arranged to generate an encoded speech signal by applying a speech encoding algorithm to the audio signal received from the audio processor 303.

The system of FIG. 3 further comprises an EMG processor 307 coupled to an EMG sensor 309 (which may correspond to the EMG sensor 107 of FIG. 1). The EMG processor 307 may receive the EMG signal and proceed to amplify, filter and digitize this. The EMG processor 307 is furthermore coupled to an encoding controller 311 which is furthermore coupled to the encoder 305. The encoding controller 311 is arranged to modify the encoding processing dependent on the EMG signal.

Specifically, the encoding controller 311 comprises functionality for determining a speech characteristic indication relating to the acoustic speech signal received from the speaker. The speech characteristic is determined on the basis of the EMG signal and is then used to adapt or modified the encoding process applied by the encoder 305.

In a specific example, the encoding controller 311 comprises functionality for detecting the degree of voicing in the speech signal from the EMG signal. Voiced speech is more periodic whereas unvoiced speech is more noise-like. Modern speech coders generally avoid a hard classification of the signal into voiced or unvoiced speech. Instead, a more appropriate measure is the degree of voicing, which can also be estimated from the EMG signal. For example the number of zero crossings is a simple indication of whether the signal is voiced or unvoiced. Unvoiced signals tend to have more zero crossings due to their noise-like nature. Since the EMG signal is free from acoustic background noise, voiced/unvoiced detections are more robust.

Accordingly, in the system of FIG. 3, the encoding controller 311 controls the encoder 305 to select encoding parameters depending on the degree of voicing. Specifically, the parameters of a speech coder such as the Federal Standard MELP (Mixed Excitation Linear Prediction) coder may be set depending on the degree of voicing.

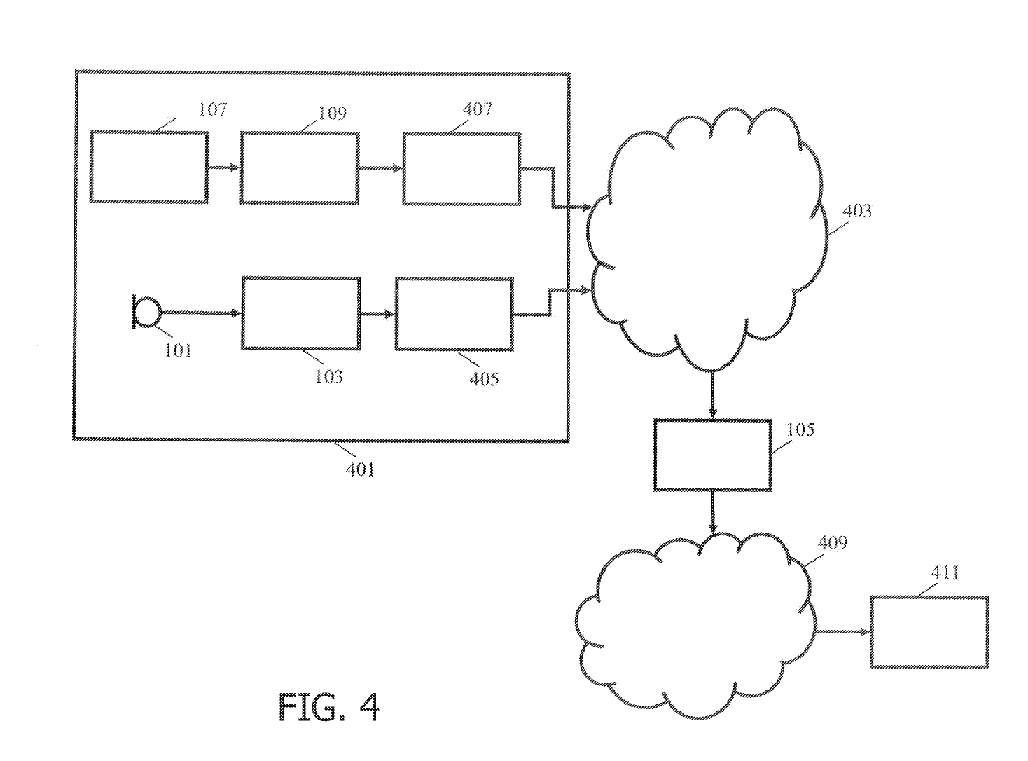

FIG. 4 illustrates an example of a communication system comprising a distributed speech processing system. The system may specifically comprise the elements described with reference to FIG. 1. However, in the example, the system of FIG. 1 is distributed in a communication system and is enhanced by communication functionality supporting the distribution.

In the system, a speech source unit 401 comprises the microphone 101, the audio processor 103, the EMG sensor 107, and the EMG processor 109 described with reference to FIG. 1.

However, the speech processor 105 is not located within the speech source unit 401 but rather is located remotely and connected to the speech source unit 401 via a first communication system/network 403. In the example, the first communication network 403 is a data network such as e.g. the Internet.

Furthermore, the sound source unit 401 comprises first and second data transceivers 405, 407 which are capable of transmitting data to the speech processor 105 (which comprises a data receiver for receiving the data) via the first communication network 403. The first data transceiver 405 is coupled to the audio processor 103 and is arrange to transmit data representing the audio signal to the speech processor 105. Similarly, the second data transceiver 407 is coupled to the EMG processor 109 and is arrange to transmit data representing the EMG signal to the speech processor 105. Thus, the speech processor 105 can proceed to perform speech enhancement of the acoustic speech signal based on the EMG signal.

In the example of FIG. 4, the speech processor 105 is furthermore coupled to a second communication system/network 409 which is a voice only communication system. For example, the second communication system 409 may be a traditional wired telephone system.

The system furthermore comprises a remote device 411 coupled to the second communication system 409. The speech processor 105 is further arranged to generate an enhanced speech signal based on the received EMG signal and to communicate the enhanced speech signal to the remote device 411 using the standard voice communication functionality of the second communication system 409. Thus, the system may provide an enhanced speech signal to the remote device 409 using a standardized voice only communication system. Furthermore, as the enhancement processing is performed centrally, the same enhancement functionality may be used for a plurality of sound source units thereby allowing a more efficient and/or lower complexity system solution.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A speech signal processing system comprising:
first means (103) for providing a first signal representing an acoustic speech signal for a speaker;
second means (109) for providing a second signal representing an electromyographic signal for the speaker captured simultaneously with the acoustic speech signal, and
processing means (105) for processing the first signal in response to the second signal to generate a modified speech signal.

2. The speech signal processing system of claim 1 further comprising an electromyographic sensor (107) arranged to generate the electromyographic signal in response to a measurement of skin surface conductivity of the speaker.

3. The speech signal processing system of claim 1 wherein the processing means (105, 209, 213) is arranged to perform a speech activity detection in response to the second signal and the processing means (105, 207, 211) is arranged to modify a processing of the first signal in response to the speech activity detection.

4. The speech signal processing system of claim 3 wherein the speech activity detection is a pre-speech activity detection.

5. The speech signal processing system of claim 3 wherein the processing comprises an adaptive processing of the first signal, and the processing means (105, 207, 209, 211, 213) is arranged to adapt the adaptive processing only when the speech activity detection meets a criterion.

6. The speech signal processing system of claim 5 wherein the adaptive processing comprises an adaptive audio beam forming processing.

7. The speech signal processing system of claim 5 wherein the adaptive processing comprises an adaptive noise compensation processing.

8. The speech signal processing system of claim 1 wherein the processing means (105, 311) is arranged to determine a speech characteristic in response to the second signal, and to modify a processing of the first signal in response to the speech characteristic.

9. The speech signal processing system of claim 8 wherein the speech characteristic is a voicing characteristic and the processing of the first signal is varied dependent on a current degree of voicing indicated by the voicing characteristic.

10. The speech signal processing system of claim 8 wherein the modified speech signal is an encoded speech signal and the processing means (105, 311) is arranged to select a set of encoding parameters for encoding the first signal in response to the speech characteristic.

11. The speech signal processing system of claim 1 wherein the modified speech signal is an encoded speech signal, and the processing of the first signal comprises a speech encoding of the first signal.

12. The speech signal processing system of claim 1 wherein the system comprises a first device (401) comprising the first and second means (103, 109) and a second device remote from the first device and comprising the processing device (105), and wherein the first device (401) further comprise means (405, 407) for communicating the first signal and the second signal to the second device.

13. The speech signal processing system of claim 12 wherein the second device further comprises means for transmitting the speech signal to a third device (411) over a speech only communication connection.

14. A method of operation for a speech signal processing system, the method comprising:
providing a first signal representing an acoustic speech signal of a speaker;
providing a second signal representing an electromyographic signal for the speaker captured simultaneously with the acoustic speech signal, and
processing the first signal in response to the second signal to generate a modified speech signal.

15. A computer program product enabling the carrying out of a method according to claim 14.
